(19) United States
(12) Patent Application Publication
(10) Pub. No.: US 2017/0063423 A1
(43) Pub. Date: Mar. 2, 2017

(54) Novel Protective Cell Phone Case

(71) Applicant: Cery Perle, Miami Beach, FL (US)

(72) Inventor: Cery Perle, Miami Beach, FL (US)

(21) Appl. No.: 15/246,478

(22) Filed: Aug. 24, 2016

Related U.S. Application Data
(60) Provisional application No. 62/209,240, filed on Aug. 24, 2015.

(51) Int. Cl. H04B 1/3888; B32B 27/40; B32B 27/36; B32B 7/12; B32B 27/08

(52) U.S. Cl. CPC H04B 1/3888; B32B 7/12; B32B 27/08; B32B 27/36; B32B 27/40; B32B 2307/412; B32B 2571/00

(57) ABSTRACT

A cell phone case cover having four layer system screen protector including a first polyethylene terephthalate (PET) layer, an optically clear adhesive (OCA) layer, a second polyethylene terephthalate (PET) layer and a silicon adhesive layer in combination with a protective case body constructed to protect the phone and allow to activate touch screen capabilities on side positioned curved screen displays.

### INDEX TO RELATED APPLICATIONS

This application is a non-provisional of and claims benefit to U.S. Provisional Patent Application Ser. No. 62/209,240 filed Aug. 24, 2015 the disclosure of which is incorporated herein by reference in its entirety.

### BACKGROUND OF THE INVENTION

With advances in cell phone technology, it becomes more important to advance the technology related to protecting these devices. Unfortunately, most focus is on the cell phones and not on the protection. The present invention addresses this deficiency by providing a novel system for protecting cell phones.

### SUMMARY OF THE INVENTION

The invention is a significant improvement in protecting current phones with curved screens.

The configuration including PVC plastic frame along with tempered glass imparts an improved protection in a wrap around system.

In one embodiment, the invention is a one piece case. In another embodiment, it is a two piece case. In another embodiment, it is a three piece case.

Although there are particular examples provided herein, the present invention includes the disclosed embodiments and combinations thereof including, but not limited to combinations of the materials in the case.

Additionally contemplated are any combination of the film, and the glass whether each piece is separately assembled by the customer (e.g. to place film, glass, case front and back, etc.)

or the glass and film come blended, adhered, stacked, fused, bonded or made as one, or otherwise.

The invention includes variants relating to specific phones and is not limited to any shape, dimension, thickness (including thickness or grade of materials used), or color.

In one embodiment, the present invention is a cell phone case system comprising:

a protective base;

a four layer screen protector system including a first layer consisting of either a polyethylene terephthalate (PET) layer or a thermoplastic polyurethane (TPU), a second layer consisting of an optically clear adhesive (OCA) disposed directly onto said first layer , a third layer consisting of either a second PET or a second TPU layer disposed directly on said OCA layer and a fourth layer consisting of a silicon adhesive is disposed on said second layer.

In one embodiment the case has transparent side portions constructed and arranged to view side edge displays of cell phones and permit touch screen activation of said side portions through said transparent edges. This is an advancement over current cases as typically in order to provide protection for the edges, the case is prohibitively thick and will not allow touch screen access on edge positioned displays.

In one embodiment, the invention is provided as a one piece configuration.

In one embodiment, the invention is provided as a two piece configuration consisting of a base plate and a screen protector.

In one embodiment, the invention is provided as a three piece configuration consisting of a back plate, a front plate and a screen protector.

In one embodiment, the invention provides for touch screen access of edge positioned screens and is provided as a one piece configuration.

In one embodiment, the invention provides for touch screen access of edge positioned screens and provided as a two piece configuration consisting of a base plate and a screen protector.

In one embodiment, the invention provides for touch screen access of edge positioned screens and provided as a three piece configuration consisting of a back plate, a front plate and a screen protector.

In one embodiment, the screen protector with a thickness ratio of first layer:second layer:third layer:fourth layer thickness is about 1:0.8-1.2:0.4-0.6: 0.35-0.55.

In one embodiment, the screen protector with a thickness ratio of 1:1:0.5:0.4.

### BRIEF DESCRIPTION OF THE SEVERAL VIEWS OF THE DRAWINGS

FIG. 1 is a perspective view of a conventional assembled cell phone case.

FIG. 2 is a side cross-sectional view demonstrative of assembled compositional components according to one embodiment of the present invention.

FIG. 3 is a perspective view demonstrative of assembly of the case according to one embodiment of present invention.

FIG. 4 a front view from FIG. 3.

FIG. 5 is a side view from FIG. 4.

FIG. 6 is a sequential view of the components in a single piece protective case according to one embodiment of the present invention.

FIG. 7 is a front view of a three-piece assembly according to one embodiment of the present invention.

FIG. 8 is a side view from FIG. 7.

FIG. 9 is a top edge view from FIG. 7.

FIG. 10 is a front view of a bottom plate for a three-piece case assembly point to one embodiment of the present invention.

FIG. 11 is a side view from FIG. 10.

FIG. 12 is an edge view from FIG. 10.

FIG. 13 is demonstrative of the disassembled components of a three-piece case assembly according to one embodiment of the present invention.

FIG. 14 is a front view of a two-piece case assembly point to one embodiment of the present invention.

FIG. 15 is a side view from FIG. 14.

FIG. 16 is a top edge view from FIG. 14.

FIG. 17 is demonstrative of the disassembled components of a two-piece case assembly according to one embodiment of the present invention.

FIG. 18 is a side partial cross-section view of a flexible case according to one embodiment of the present invention in an unactivated position.

FIG. 19 is a side partial cross-section view of a flexible case according to one embodiment of the present invention in an activated position.

### DETAILED DESCRIPTION OF THE PREFERRED EMBODIMENT

The present invention represents an advancement in cell phone and smartphone protection technology. Recently, smart phones are configured with side edges incorporating displays thereon. Current cell phone protective cases are deficient in that they often obscure the side edges display.

Furthermore, it becomes difficult to provide a cell phone protective device that is both protective of the cell phone contained therein and provides for viewing of the side edge phone display.

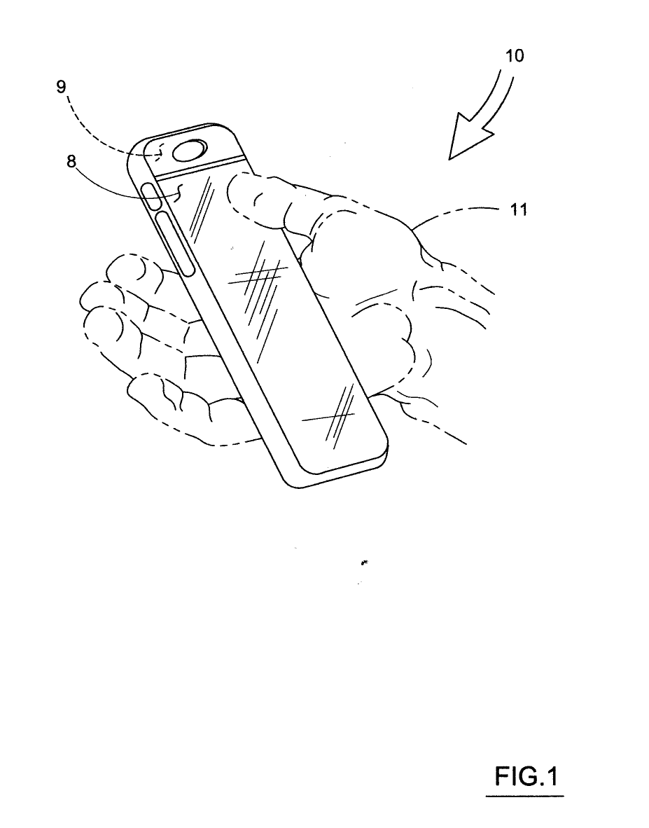

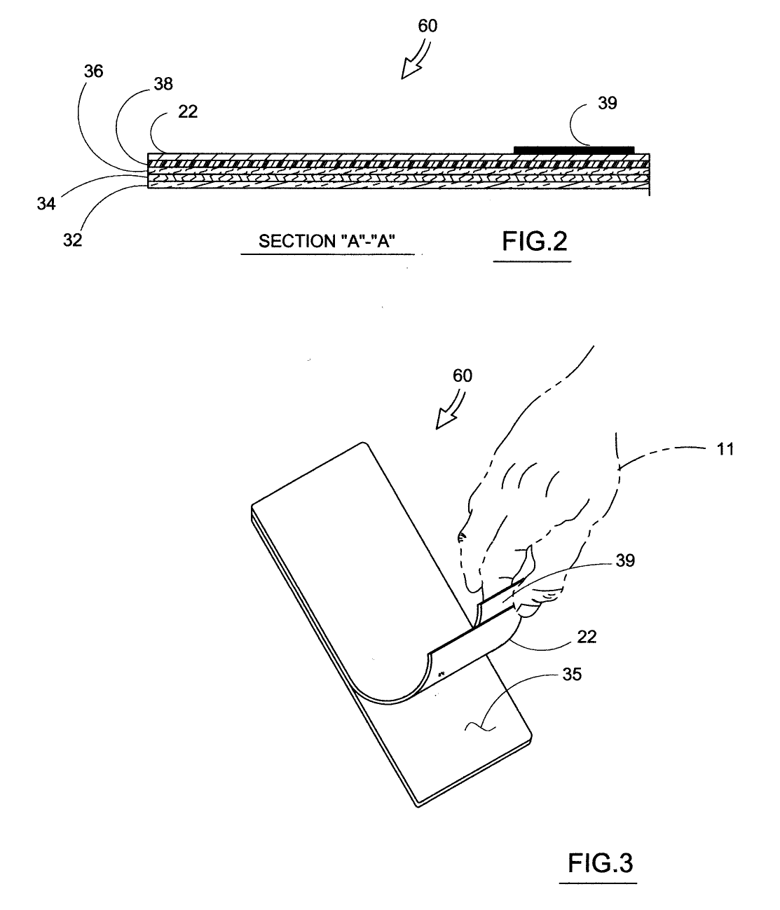

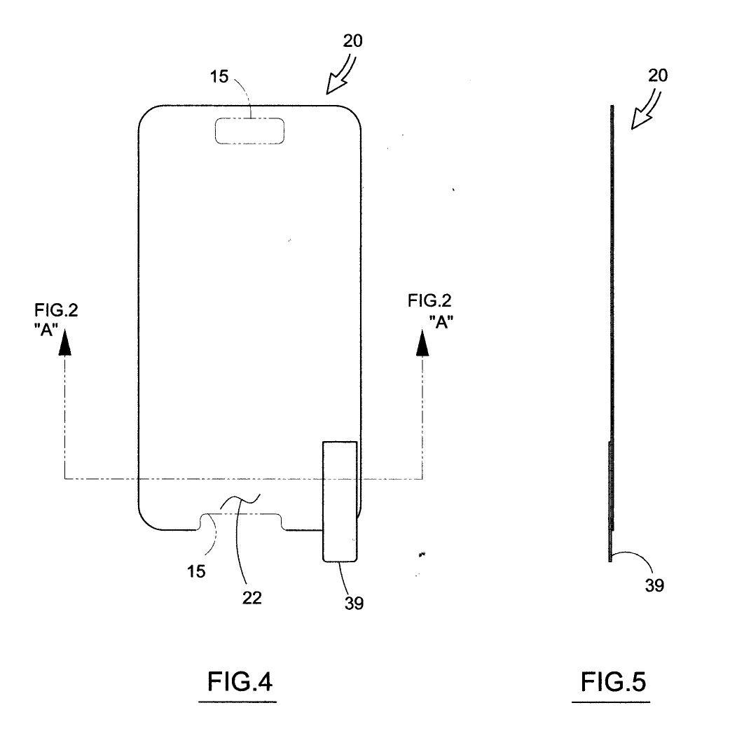

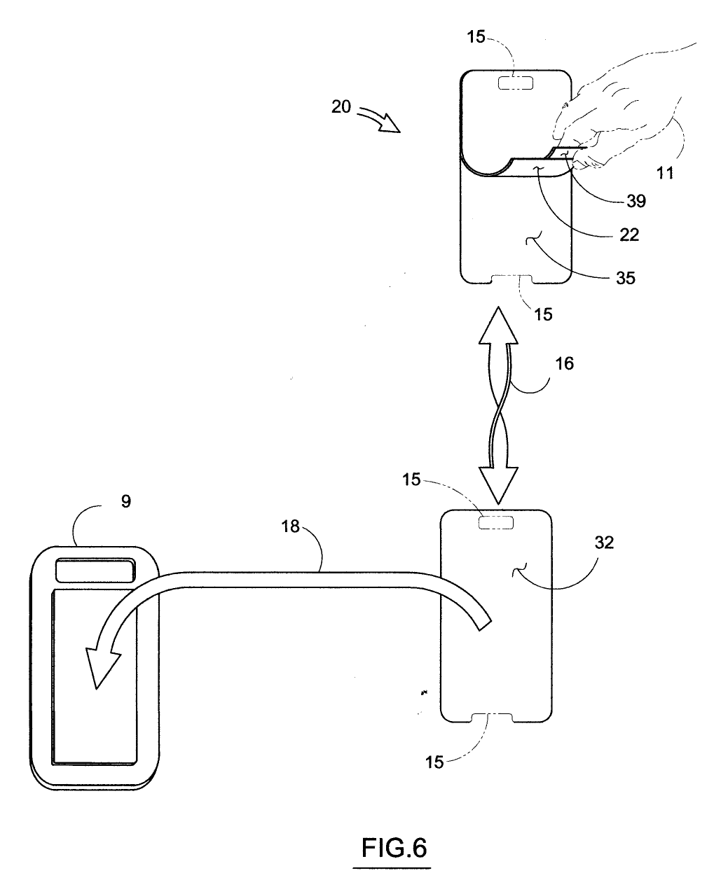

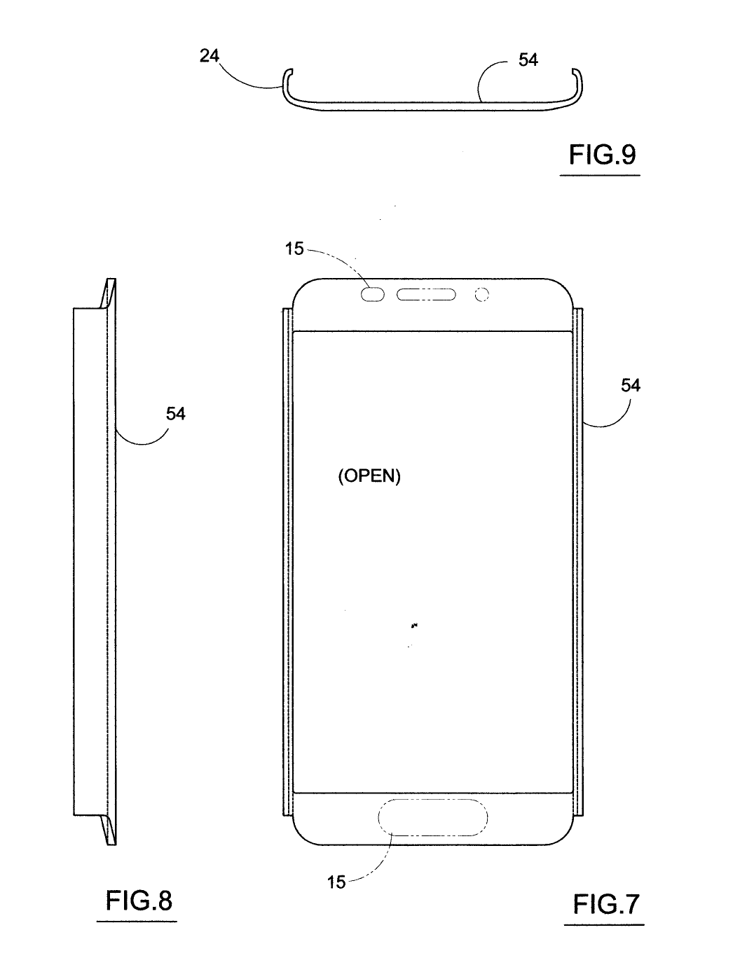

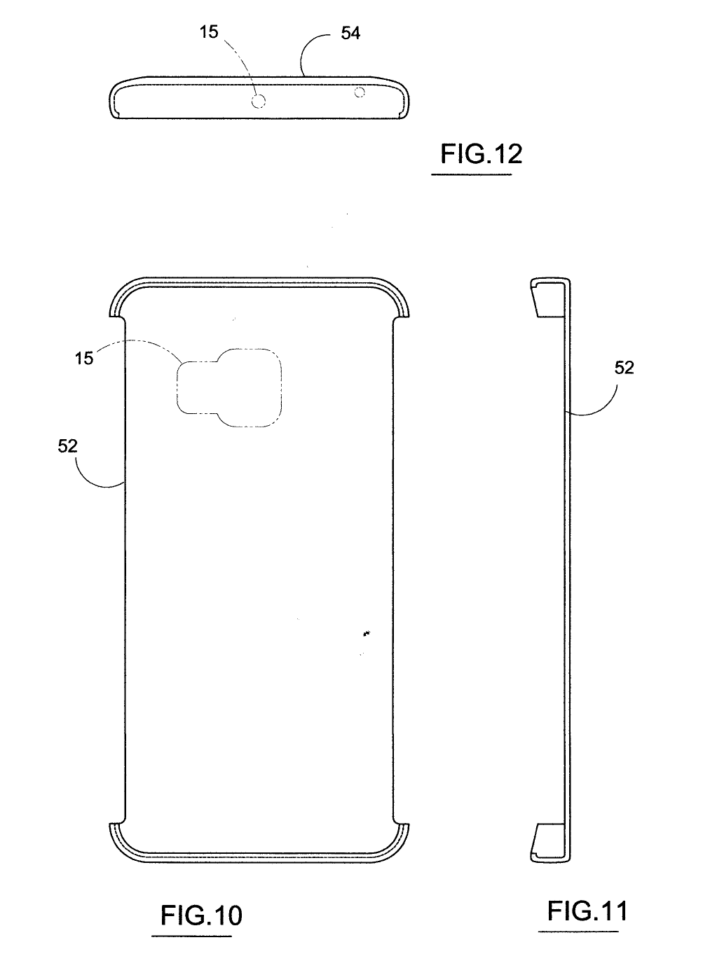

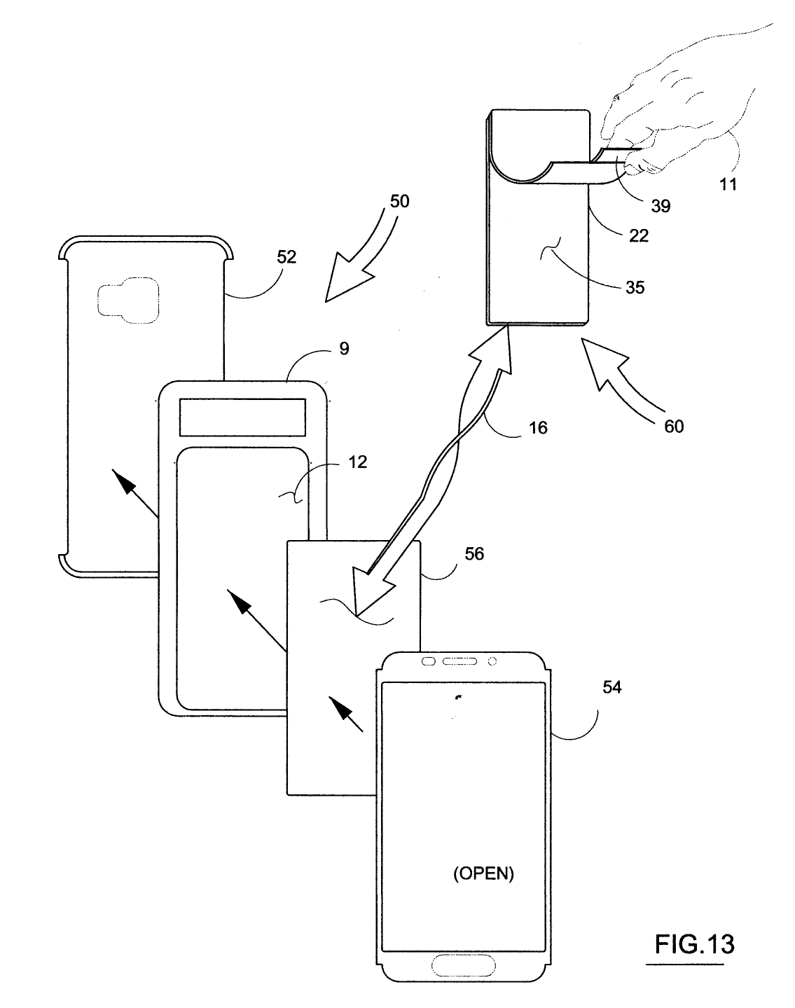

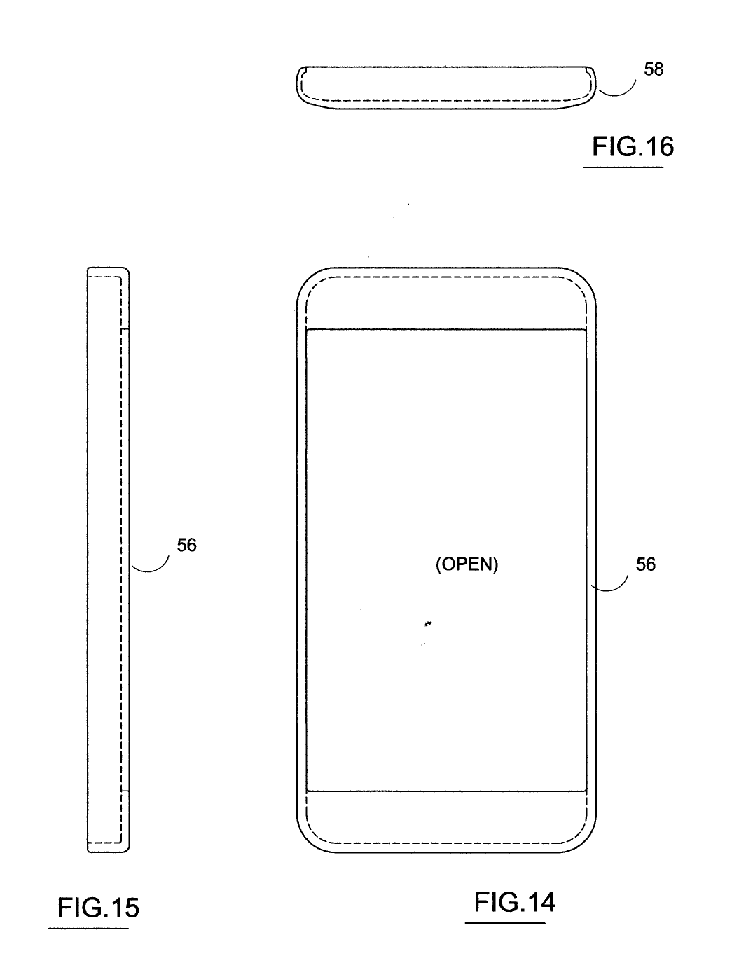

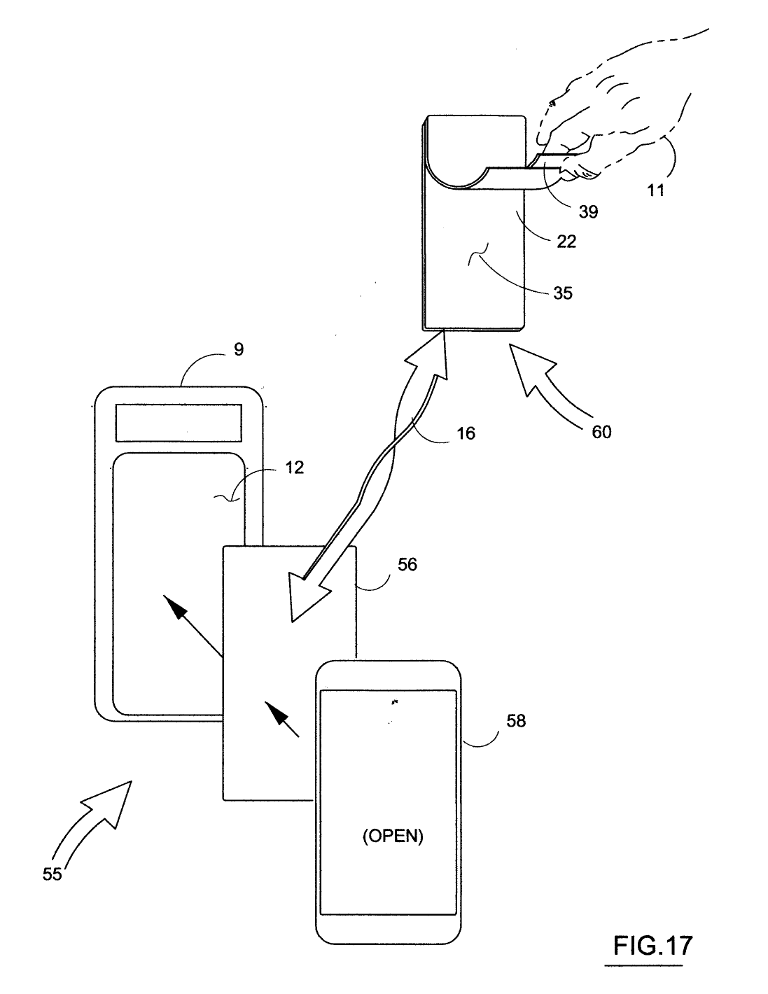

As demonstrated in FIG. 1, a conventional cell phone 10 has a protective case eight a cell phone nine that is held in a user's hand 11.

The present invention provides for a multi-compositional case whereby a screen protector 60 is provide with a removable cover film layer 22, and the screen protector is formed with: a first layer consisting of either a polyethylene terephthalate (PET) or a thermoplastic polyurethane (TPU) layer 32, a second layer 34 consisting of an optically clear adhesive (OCA) disposed directly onto said first layer, a third layer 26 consisting of either a second PET layer or a second TPU layer disposed directly on said OCA layer and a fourth layer 38 consisting of a silicon adhesive is disposed on said second PET layer.

Base plate 54 is configured with curved transparent edges 24. In configuring with transparent edges 24 a user can see the side displays of cell phones so configured.

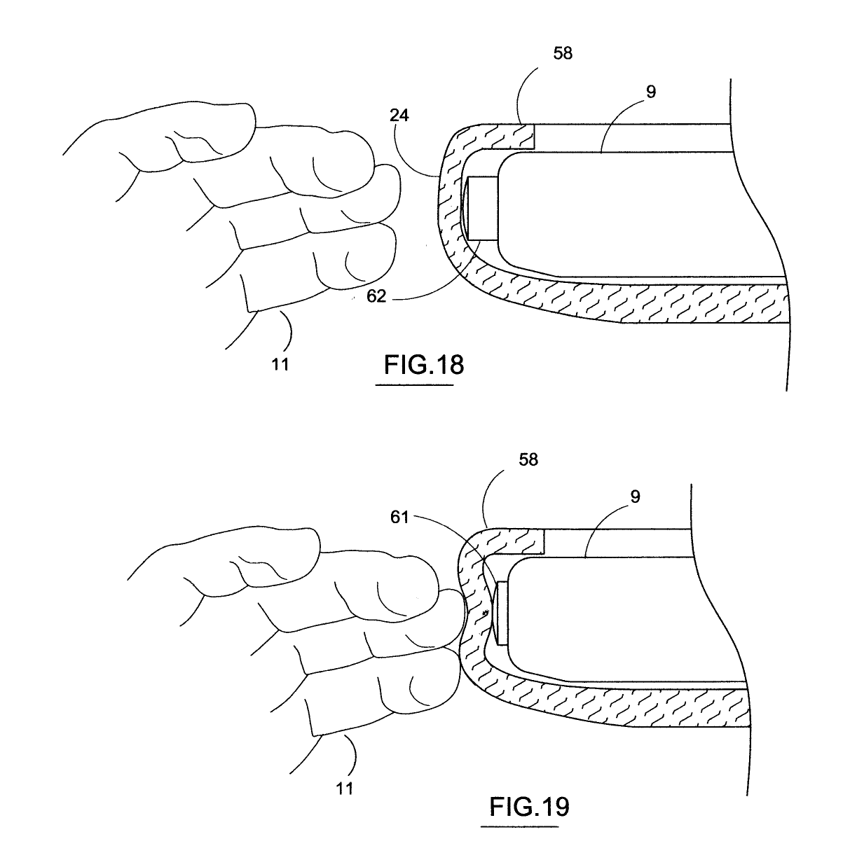

In one embodiment, back plate 52 is combined with faceplate 56 and front plate 54. Cell phone nine having screen 12 is nested in assembly 50 and fully protected once assembled. A one embodiment, plate 56 is constructed and arranged with want more more flexible regions 58 that are constructed and arranged to be on activated at West, as demonstrated in FIG. 18 and, to be activated by user as demonstrated in FIG. 19 whereby flexible region 58 provides for access of a typical cell phone control button 61. Although not shown, this offset of being able to press through the side of the case is particularly well suited for cell phones utilizing side mounted displays including, but not limited to the Galaxy® Note Edge, the LG G Flex 2, and other phones with one or two curved displays on the side of the phone. The present invention provides protection for the phone and still allows the user to see the side curved display and activate the touch screen of the curved portion.

In one embodiment, present invention includes a protective faceplate and a transparent curved side edge 24 integral with said faceplate. That is to say, they are formed of a single contiguous piece.

In another embodiment, the present invention provides a fused curved side edge 24 permanently attached to protective faceplate. In this embodiment, curved side edge 24 is adhesively attached in a manner such that the attachment is virtually indistinguishable to an observer.

In one embodiment, curved side edge 24 is formed of PET, being “polyethylene terephthalate.”

One important aspect of the present invention includes curved side edge 24 being constructed and arranged with sufficient strength to protect a phone and still permitting a user to touch curved side edge 24 and interact with an edge positioned touchscreen.

In one embodiment, curved side edge 24 is formed of polyester film with a scratch resistant matte coating on one side and a silicone adhesive on the other. It is a seamless added piece of PET or TPC film to cover the edges of the curve keeping in line with exiting configurations of the case.

In one embodiment, there is a blend of temper glass with PET/TPC, which produces a product for all curved edged phones as the PET/TPC film can easily be molded to the curved glass

This embodiment is contemplated as either a two piece or single piece back cases. In the 2-piece embodiment, there is still a front case.

In another embodiment, curved side edge 24 is formed of TPU (thermoplastic polyurethane). This is chemically-enhanced plastic whose properties include scratch resistance, elasticity, oil and grease resistance, and increased toughness. Since the material is elastic, it has limited “self-healing” abilities. This means that its slight softness gives it the power to absorb non-extreme impact, such as most drops and lighter scratches, while retaining all or most of its original composition. For example, lighter scratches usually leave just a small dent in the soft plastic, which slowly returns to normal.

The case of the present invention provides the following advantages:

Excellent Anti-Shock Properties—can-Absorbs a Direct Hit—
0.30 mm, 5H Hardness including TPU and PET Layers (this can vary as we try to match the glass thickness to create a smooth transition
Anti-Shock, Anti-Fingerprint and Anti-Glare Properties
HD clarity—92% Transparency
Precision Manufacturing Insures a Good Fit

In one embodiment, a scratch resistant and scratch preventive film is associated with the case and/or screen glass region. “Associated” includes any type of formation, coating, disposition, or other association that results in the end product exhibiting the desired resistance to scratches.

In one embodiment a material is disposed on the outer surface provides significant improvement over conventional cases. Coatings include use of Ultraviolet—Electron Beam UV/EB coatings (including, but not limited to curable coatings based on acrylate chemistry), polycarbonates, polymethylmethacrylate (PMMA), Polyethylene terephthalate (PET), and combinations thereof including monomers, polymers, isomers, derivatives, and related compounds.

In one embodiment, the coating is incorporated with a tempered glass component.

In one embodiment, an uncoated formulated tempered glass component is used.

In one embodiment, the glass is replaced with a cover incorporating PMMA.

In one embodiment, (PMMA), and PET will be on the curve edge of phones and/or blended into the glass to form to the edges imparting each of transparency and scratch resistance on the edges.

The case in the various embodiments exhibits increased resistance to scratches and other surface anomalies in repeated tests.

In one embodiment, the case material is formed of multiple layers. An anti-fingerprint layer is formed of a first Polyethylene terephthalate (PET) layer. A suitable optically clear adhesive (OCA) is disposed directly onto the PET layer. A second PET layer is then disposed on the OCA layer.

Finally, a silicon adhesive is disposed on the second PET layer.

Thus, a four layer system is formed.

In a preferred embodiment, the ratio of thickness of the layers in the screen protector is first layer:secod layer:third layer:fourth layer thickness is about 1:0.8-1.2:0.4-0.6: 0.35-0.55.

In one particular embodiment wherein the four layer thickness ratio of the screen protector is 1:1:0.5:0.4.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A cell phone case system comprising:
a protective base;
a four layer screen protector system including a first layer consisting of either a polyethylene terephthalate (PET) layer or a thermoplastic polyurethane (TPU), a second layer consisting of an optically clear adhesive (OCA) disposed directly onto said first layer , a third layer consisting of either a second PET or a second TPU layer disposed directly on said OCA layer and a fourth layer consisting of a silicon adhesive is disposed on said second layer.

2. The case of claim 1 including transparent side portions constructed and arranged to view side edge displays of cell phones and permit touch screen activation of said side portions through said transparent edges.

3. The case of claim 1 provided as a one piece configuration.

4. The case of claim 1 provided as a two piece configuration consisting of a base plate and a screen protector.

5. The case of claim 1 provided as a three piece configuration consisting of a back plate, a front plate and a screen protector.

6. The case of claim 2 provided as a one piece configuration.

7. The case of claim 2 provided as a two piece configuration consisting of a base plate and a screen protector.

8. The case of claim 2 provided as a three piece configuration consisting of a back plate, a front plate and a screen protector.

9. The case of claim 1 wherein said screen protector with a thickness ratio of first layer:second layer:third layer:fourth layer thickness is about 1:0.8-1.2:0.4-0.6: 0.35-0.55.

10. The case of claim 9 wherein said screen protector with a thickness ratio of 1:1:0.5:0.4.
